(19) United States
(12) Patent Application Publication
(10) Pub. No.: US 2012/0050759 A1
(43) Pub. Date: Mar. 1, 2012

(54) IMAGE PROCESSING APPARATUS, IMAGE PROCESSING APPARATUS CONTROL METHOD, INFORMATION PROCESSING APPARATUS, INFORMATION PROCESSING APPARATUS CONTROL METHOD, AND STORAGE MEDIUM STORING PROGRAM

(75) Inventor: Toshio Yoshihara, Kawasaki-shi (JP)

(73) Assignee: CANON KABUSHIKI KAISHA, Tokyo (JP)

(21) Appl. No.: 13/127,664

(22) PCT Filed: Dec. 1, 2010
(86) PCT No.: PCT/JP10/71940

§ 371 Date: May 4, 2011

(30) Foreign Application Priority Data
Jan. 6, 2010 (JP) 2010-001566

(51) Int. Cl. H04N 1/60

(52) U.S. Cl. 358/1.9

(57) ABSTRACT

Printing is done on printing paper using a transparent toner, and the printing result is previewed. When displaying the result of printing on plain paper using the transparent toner, the display is controlled to display the luminance of a region where the transparent toner is applied, to be higher than that of an image indicating the plain paper. When applying the transparent toner to glossy paper, the display is controlled to display the luminance of the region where the transparent toner is applied, to be lower than that of an image indicating the glossy paper.

### TECHNICAL FIELD

The present invention relates to an image processing apparatus which prints an image using a transparent toner, an image processing apparatus control method, an information processing apparatus, an information processing apparatus control method, and a storage medium storing a program.

### BACKGROUND ART

Recently, multicolor printing methods using a special toner such as a transparent toner are becoming popular, in addition to electrophotographic full-color printing using four, C, M, Y, and Bk color toners. Printing using such a special toner can smoothen the rugged surface of a printed material and obtain high glossiness.

Further, a preview display technique is used to present a printed state before the start of print processing. According to the preview display technique, the user can display a printing result on the display unit and confirm it before the start of print processing. Japanese Patent Laid-Open No. 2002-103726 discloses a preview display technique capable of displaying paper quality including the smoothness, glossiness, transmittance, and color tone of paper used in printing.

However, the conventional technique does not preview the result of printing using a transparent toner for confirmation. In particular, whether glossiness increases at a portion where the transparent toner is applied changes depending on the type of paper to which the transparent toner is applied.

For example, when printing is done using the transparent toner on less glossy printing paper such as plain paper, glossiness increases in a region where the transparent toner is applied, compared to a region where no transparent toner is applied. In contrast, when printing is performed using the transparent toner on highly glossy printing paper such as glossy paper, glossiness decreases in a region where the transparent toner is applied, compared to a region where no transparent toner is applied.

In this manner, the conventional technique does not preview a printing result considering the type of printing paper.

### SUMMARY OF INVENTION

An aspect of the present invention is to eliminate the above-mentioned problems with the conventional technology. The present invention provides a mechanism of displaying the preview of printing using a transparent toner in consideration of the type of paper for use.

The present invention in its first aspect provides an image processing apparatus comprising: printing means for printing on printing paper using a transparent toner; display means for previewing a result of printing by the printing means; and display control means for, when displaying a result of printing on plain paper using the transparent toner, controlling the display means to display a luminance of a region where the transparent toner is applied, to be higher than a luminance of an image indicating the plain paper, and when displaying a result of printing on glossy paper using the transparent toner, controlling the display means to display the luminance of the region where the transparent toner is applied, to be lower than a luminance of an image indicating the glossy paper.

The present invention in its second aspect provides an information processing apparatus capable of communicating with a printing apparatus which prints on printing paper using a transparent toner, the information processing apparatus comprising: display means for previewing a result of printing by the printing apparatus; and display control means for, when displaying a result of printing on plain paper using the transparent toner, controlling the display means to display a luminance of a region where the transparent toner is applied, to be higher than a luminance of an image indicating the plain paper, and when displaying a result of printing on glossy paper using the transparent toner, controlling the display means to display the luminance of the region where the transparent toner is applied, to be lower than a luminance of an image indicating the glossy paper.

The present invention in its third aspect provides a method of controlling an image processing apparatus, the method being executed by the image processing apparatus, the method comprising: a printing step of printing on printing paper using a transparent toner; a display step of causing a display unit to preview a result of printing in the printing step; and a display control step of, when displaying a result of printing on plain paper using the transparent toner, controlling the display unit to display a luminance of a region where the transparent toner is applied, to be higher than a luminance of an image indicating the plain paper, and when displaying a result of printing on glossy paper using the transparent toner, controlling the display unit to display the luminance of the region where the transparent toner is applied, to be lower than a luminance of an image indicating the glossy paper.

The present invention in its fourth aspect provides a method of controlling an information processing apparatus, the method being executed by the information processing apparatus capable of communicating with a printing apparatus which prints on printing paper using a transparent toner, the method comprising: a display step of causing a display unit to preview a result of printing by the printing apparatus; and a display control step of, when displaying a result of printing on plain paper using the transparent toner, controlling the display unit to display a luminance of a region where the transparent toner is applied, to be higher than a luminance of an image indicating the plain paper, and when displaying a result of printing on glossy paper using the transparent toner, controlling the display unit to display the luminance of the region where the transparent toner is applied, to be lower than a luminance of an image indicating the glossy paper.

According to the present invention, the preview of printing using a transparent toner can be displayed in consideration of the type of paper for use.

Further features of the present invention will become apparent from the following description of exemplary embodiments with reference to the attached drawings.

### BRIEF DESCRIPTION OF DRAWINGS

FIG. 1 is a block diagram showing the configuration of an image processing system;

FIG. 2 is a sectional view showing the internal arrangement of an MFP;

FIG. 3 is a block diagram showing the internal arrangement of a local PC;

FIGS. 4A and 4B are block diagrams showing the arrangement of the PDL processing unit of the MFP;

FIGS. 5A and 5B are block diagrams showing the arrangements of a transparent form image processing unit and image processing unit;

FIG. 6 is a flowchart showing the sequence of image processing and normal print processing performed by a data processing unit;

FIGS. 7A, 7B, and 7C are views showing the surface of a transparent toner and transparent form image data;

FIGS. 8A and 8B are flowcharts showing the sequences of processes by the PDL processing unit and transparent form image processing unit;

FIGS. 9A and 9B are views each showing a screen for selecting a transparent form;

FIG. 10 is a view showing transparent toner surfaces for respective cases in normal printing;

FIG. 11 is a flowchart showing the sequence of transparent toner printing result preview display processing;

FIG. 12 is a view showing a transparent toner printing result preview display;

FIG. 13 is a flowchart showing the sequence of processing by the image processing unit;

FIG. 14 is a flowchart showing the sequence of image processing and pre-printout processing performed by the data processing unit;

FIGS. 15A and 15B are views showing transparent toner surfaces for respective cases in pre-printing;

FIG. 16 is a view showing a transparent toner printing result preview screen;

FIG. 17 is a flowchart showing the sequence of transparent toner printing result preview display processing; and

FIG. 18 is a flowchart showing the sequence of processing by the image processing unit in pre-printing.

### DESCRIPTION OF EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. Note that the same reference numerals denote the same parts, and a repetitive description thereof will be omitted.

### First Embodiment

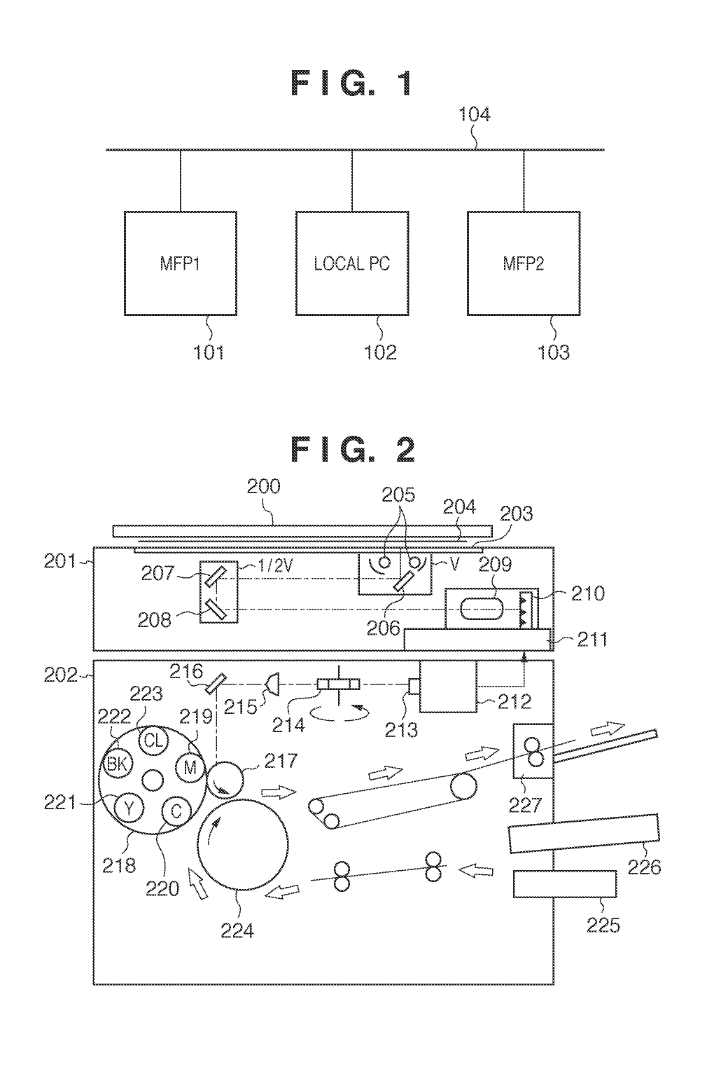

FIG. 1 is a block diagram showing the configuration of an image processing system according to the first embodiment of the present invention. Multifunctional peripherals (to be referred to as MFPs) 101 and 103 serving as an example of an image processing apparatus, and a local PC 102 serving as an example of an information processing apparatus are connected to a LAN 104 built in an office. These apparatuses can communicate with each other via the LAN 104. The MFPs 101 and 103 perform image processing for input image data obtained by reading a document image. The MFP which has read the document image prints the result of the image processing. It is also possible to perform image processing for document image data read by the MFP 101 and print by the MFP 103. It is still possible to interpret a page description language (PDL) transmitted from the local PC 102 and print by the MFP 101 or 103. The local PC 102 and the MFP 101 or 103 are separately configured as shown in FIG. 1, but may be integrated. In this case, the integrated configuration functions as an image processing apparatus in the embodiment.

<Arrangement of MFP>

FIG. 2 is a sectional view showing the internal arrangement of the MFP 101 or 103. As shown in FIG. 2, an image scanner (image reading unit) 201 reads a document image and performs digital signal processing for the read document image data. A printer 202 prints, on paper, a full-color image corresponding to the document image data read by the image scanner 201.

The image scanner 201 includes a mirror-surface pressure plate 200. A lamp 205 irradiates a document 204 on a document glass (to be referred to as a platen) 203, and mirrors 206, 207, and 208 guide the reflected light. The irradiation light forms an image on a 3-line solid-state image sensor (to be referred to as a CCD) 210 via a lens 209, sending three, red (R), green (G), and blue (B) image signals serving as full-color information to a data processing unit 211. Note that the lamp 205 and mirror 206 mechanically move at a speed v, and the mirrors 207 and 208 mechanically move at a speed v/2 in a direction perpendicular to the electrical scanning (main scanning) direction of the line sensor. As a result, the entire document surface can be scanned (sub-scanned). The document 204 is read at a resolution of 600 dpi (dots/inch) in both main scanning and sub-scanning. A read image signal is stored for each document page in a data storage unit (not shown) in the data processing unit 211.

The data processing unit 211 electrically processes an internally stored image signal for each pixel, decomposes it into magenta (M), cyan (C), yellow (Y), and black (Bk) components, and sends them to the printer 202. Also, the data processing unit 211 internally generates transparent image data (CL) for each pixel, and similarly sends it to the printer 202.

The sent M, C, Y, Bk, and CL image signals are input to a laser driver 212. The laser driver 212 modulates and drives a semiconductor laser 213 in accordance with the received image signals. The laser beam scans a photosensitive drum 217 via a polygon mirror 214, f-θ lens 215, and mirror 216. Similar to reading, write is performed at a resolution of 600 dpi (dots/inch) in both main scanning and sub-scanning.

A rotary developing unit 218 includes a magenta developing unit 219, cyan developing unit 220, yellow developing unit 221, black developing unit 222 and clear (transparent) developing unit 223. The five developing units 219 to 223 alternately come into contact with the photosensitive drum 217, developing electrostatic images formed on the photosensitive drum with the respective color toners. A sheet supplied from a sheet cassette 225 or 226 is wound around a transfer drum 224 to transfer the image developed on the photosensitive drum onto the sheet.

After sequentially transferring the five, C, M, Y, Bk and CL (transparent) toners, the sheet passes through a fixing unit 227 to fix the toners onto the sheet, and then is discharged. Instead of discharging the sheet, the sheet may be printed again through the above processes and then discharged.

<Arrangement of Local PC>

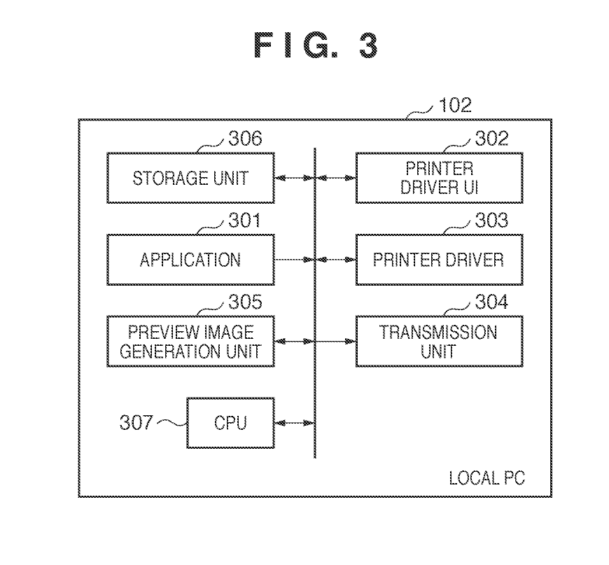

FIG. 3 is a block diagram showing the arrangement of the local PC 102 (to be also simply referred to as a PC).

For example, image data to be printed is created using an application 301 (such image data will also be called application data). When transmitting image data from the user to the MFP, and saving it in the internal storage unit of the MFP or printing it out, a printer driver UI 302 receives the instruction and transmits it to a printer driver 303.

The printer driver 303 converts application data into PDL data. The PDL language used for the PDL data is, for example, LIPS or PS. A transmission unit 304 transmits the created PDL data to, for example, the MFP 101 out of the MFPs 101 and 103. A preview image generation unit 305 generates a preview image indicating the final printing result. Details of the preview image generation unit 305 will be described later. The storage unit 306 stores a transparent form and paper data. The transparent form indicates a portion where the transparent toner is applied. The MFP applies the transparent toner in accordance with the transparent form. The paper data includes parameters indicating a plurality of types of paper usable in the MFP, and parameters indicating surface smoothness, which changes depending on the paper type. The paper data is used for processing of generating preview image data. The paper data may be registered in advance in the local PC 102 by the user, or acquired from the paper database of the MFP and registered. The printer driver UI 302 reads out a transparent form and paper data from a storage unit 306. A CPU 307 controls these blocks via a bus or the like.

<Arrangement of Data Processing Unit 211 of MFP>

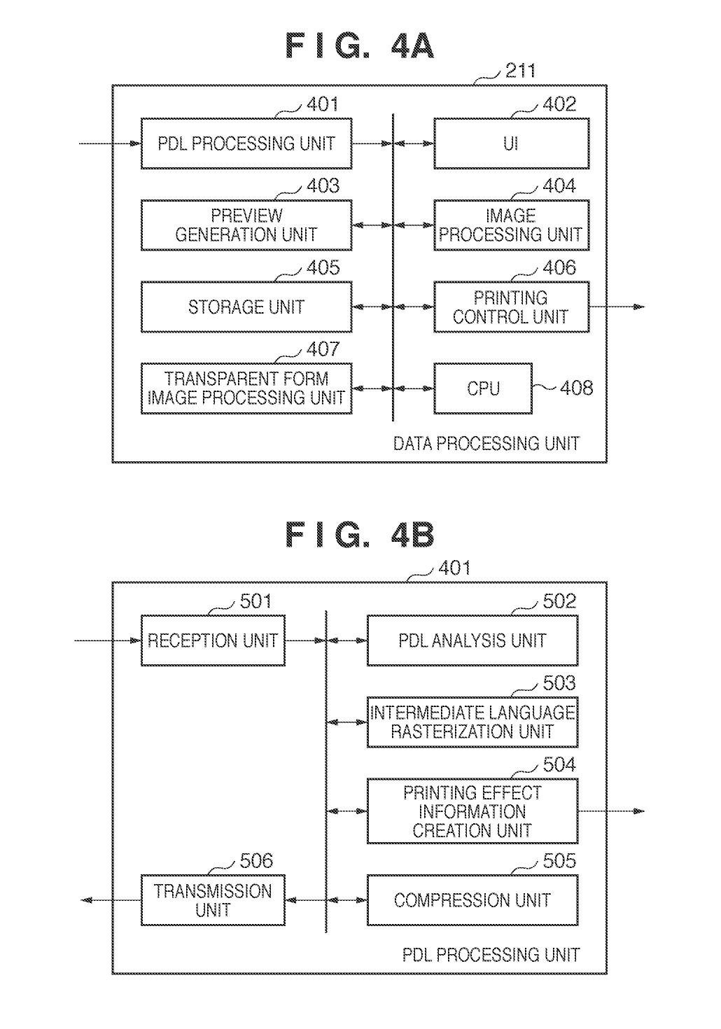

FIG. 4A is a block diagram showing the arrangement of the data processing unit 211 (corresponding to 211 in FIG. 2) mounted in each of the MFPs 101 and 103. As shown in FIG. 4A, the data processing unit 211 includes a PDL processing unit 401, UI 402, preview generation unit 403, image processing unit 404, storage unit 405, printing control unit 406, and transparent form image processing unit 407. A CPU 408 controls the respective blocks via a bus or the like.

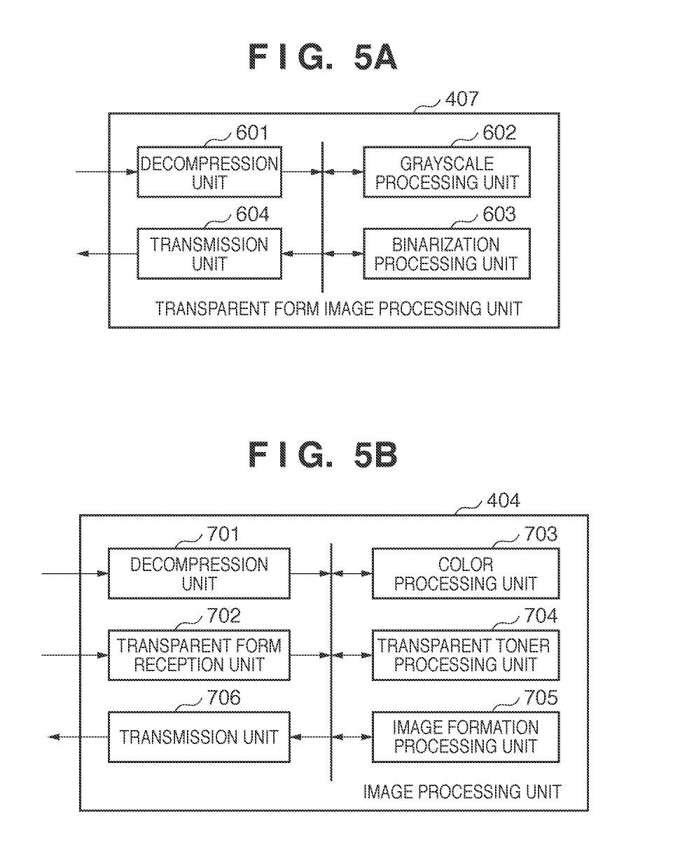

FIG. 4B is a block diagram showing details of the arrangement of the PDL processing unit 401 shown in FIG. 4A. As shown in FIG. 4B, the PDL processing unit 401 includes a reception unit 501, PDL analysis unit 502, intermediate language rasterization unit 503, printing effect information creation unit 504, compression unit 505, and transmission unit 506. FIG. 5A is a block diagram showing the arrangement of the transparent form image processing unit 407 shown in FIG. 4A. As shown in FIG. 5A, the transparent form image processing unit 407 includes a decompression unit 601, grayscale processing unit 602, binarization processing unit 603, and transmission unit 604. FIG. 5B is a block diagram showing the arrangement of the image processing unit 404 shown in FIG. 4A. As shown in FIG. 5B, the image processing unit 404 includes a decompression unit 701, transparent form reception unit 702, color processing unit 703, transparent toner processing unit 704, image formation processing unit 705, and transmission unit 706.

<Normal Printout Processing>

The MFPs 101 and 103 have the same arrangement. Although the MFP 101 will be described, the following description also applies to the MFP 103.

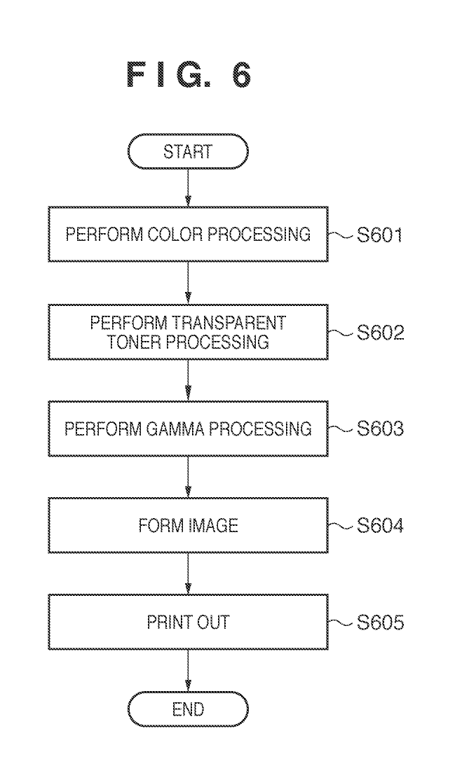

FIG. 6 is a flowchart showing the sequence of image processing and normal print processing performed by the data processing unit 211 of the MFP 101. For example, the CPU 408 of the MFP 101 executes the processing shown in FIG. 6. In color processing of step S601, the color processing unit 703 of the image processing unit 404 converts R, G, and B signals from the local PC 102 or MFP 101 into C, M, Y, and Bk signals. The conversion into C, M, Y, and Bk signals is performed by matrix calculation as represented by equation (1):

$$( \begin{matrix}C \\ M \\ Y \\ Bk\end{matrix} ) = ( \begin{matrix}A 1 & A 2 & A 3 \\ A 4 & A 5 & A 6 \\ A 7 & A 8 & A 9 \\ A 10 & A 11 & A 12\end{matrix} ) ( \begin{matrix}R \\ G \\ B\end{matrix} ) \qquad ( 1 )$$

When the MFP 101 receives C, M, Y, and Bk signals, the color processing unit 703 performs density adjustment or the like in step S601.

In step S602, the transparent toner processing unit 704 calculates a transparent toner component from the C, M, Y, and Bk signals. In this case, first, the transparent toner processing unit 704 obtains the total toner amount of C, M, Y, and Bk color toners for each pixel. The total toner amount is the amount of toner applied to paper for each pixel in accordance with the total amount of C, M, Y, and Bk signals. In general, the total toner amount is expressed in percentages using the maximum value of a single color as 100. When an image signal is expressed by an 8-bit integer, the maximum value of the single color is 255. Thus, the sum of C, M, Y, and Bk is multiplied by 100/255, obtaining the total toner amount.

For example, assume that an 8-bit image signal is C=80, M=95, Y=140, and Bk=110 for a given pixel. In this case, the total toner amount is given by equation (2):

total toner amount=(C+M+Y+Bk)×100/255=167 (2)

The general upper limit value of the total toner amount is about 200 to 280, and is determined by the image creation process or the like. For example, the upper limit value of the total toner amount is determined by a toner amount which can be fixed at once by the fixing unit 227 of the MFP. The determined upper limit value is held in the memory (not shown) of the MFP. In the first embodiment, the total amount after forming a transparent toner layer needs to be equal to or lower than the upper limit value.

Assuming that the upper limit value of the total toner amount is 240, the difference between the numerical value calculated in accordance with equation (2) and the upper limit value can be regarded as a density ratio allowed for the transparent toner layer. The allowance, that is, total toner amount is given by equation (3):

allowance=240−167=73 (3)

After determining the C, M, Y, Bk, and CL (transparent toner) amounts, the image formation processing unit 705 of the image processing unit 404 corrects the gamma set in the MFP 101 for each color in step S603. In step S604, the image formation processing unit 705 performs image formation processing for each color. The image formation processing includes, for example, screen processing and error diffusion processing. Finally in step S605, the MFP 101 prints an image using C, M, Y, Bk, and CL toners.

As described above, normal printout processing in the first embodiment is the following method. More specifically, this printing method uses a function of calculating a transparent toner amount from the total toner amount of four, cyan, magenta, yellow, and black color toners, and completing printing using the four, cyan, magenta, yellow, and black color toners and the transparent toner in one print process from paper feed to discharge. This above-described printing method will be called “normal printout”.

<Printing Effect of Transparent Toner in Normal Printout>

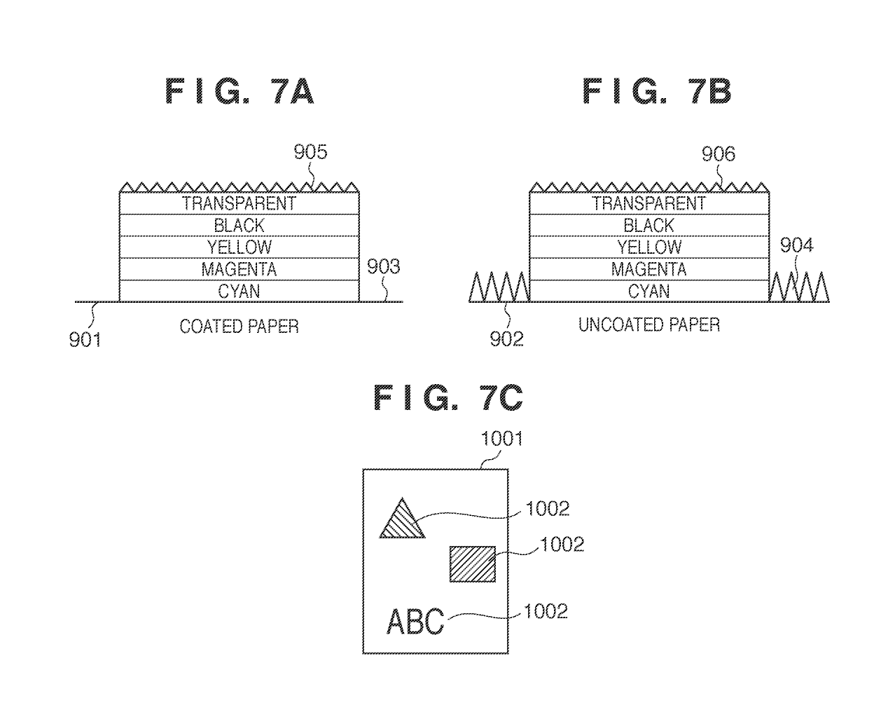

FIGS. 7A and 7B are views showing the surface of the transparent toner in normal printout. The printing effect (gloss/matte) has a relationship with the difference in surface property between paper and the transparent toner, and the difference in surface property between the transparent toner and already applied color toners. As for paper, the surface properties of coated paper 901 and uncoated paper 902 are different. A surface 903 of the coated paper (for example, glossy paper) 901 is coated and smooth. To the contrary, a surface 904 of the uncoated paper (for example, plain paper) 902 is rugged owing to the paper fiber. When normal printing using the transparent toner is done on paper, surfaces 905 and 906 of transparent toner-applied portions become slightly rugged even after passing through the fixing unit 227 of the MFP 101. When normal printing using the transparent toner is done on the coated paper 901, the printed portion (surface 905 of the transparent toner) becomes matte because the surface 903 of the coated paper 901 is smooth and the surface 905 of the transparent toner is rugged.

In contrast, when normal printing using the transparent toner is performed on the uncoated paper 902, the printed portion (surface 906 of the transparent toner) becomes glossy because the surfaces of both the paper and transparent toner are rugged but the surface of the uncoated paper 902 is rugged much more than the surface 906 of the transparent toner.

<Transparent Form Image Data>

FIG. 7C is a view exemplifying transparent form image data in the first embodiment. The MFP 101 saves transparent form image data 1001 as binary image data. A region 1002 indicates a position to which a visual effect appears when the transparent toner is used.

<Registration of Transparent Form Image>

In the first embodiment, compression and decompression use a known technique such as JPEG. The transparent toner processing unit 704 of the image processing unit 404 uses transparent form image data in transparent toner printing. The storage unit 405 stores and registers, as transparent form image data, an image indicating a portion where an effect is to be produced using the transparent toner. When the local PC 102 designates registration of a transparent form image from a driver UI screen (not shown), the reception unit 501 of the PDL processing unit 401 of the MFP 101 receives PDL data transmitted from the local PC 102.

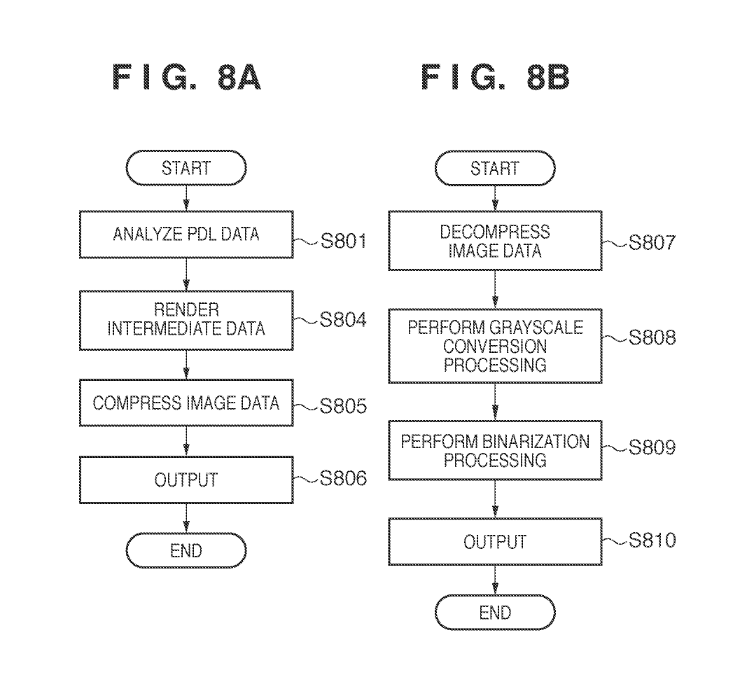

FIG. 8A is a flowchart showing the sequence of processing by the PDL processing unit 401 of the MFP 101. For example, the CPU 408 of the MFP 101 performs the processing shown in FIG. 8A by reading out and executing a program stored in the ROM (not shown). In step S801, the PDL analysis unit 502 analyzes PDL data to generate intermediate data, and the process advances to step S804. In step S804, the intermediate language rasterization unit 503 renders the intermediate data to generate image data. In step S805, the compression unit 505 compresses the image data to generate compressed data. In step S806, the transmission unit 506 outputs the compressed data to the decompression unit 601 of the transparent form image processing unit 407.

Next, the operation of the transparent form image processing unit 407 of the MFP 101 will be explained. FIG. 8B is a flowchart showing the sequence of processing by the transparent form image processing unit 407. For example, the CPU 408 of the MFP 101 performs the processing shown in FIG. 8B by reading out and executing a program stored in the ROM (not shown). In step S807, the decompression unit 601 decompresses the received compressed data. In step S808, the grayscale processing unit 602 converts the decompressed image data into grayscale data. As an example of the conversion method, when R, G, and B signals are input, they are converted into Y, U, and V signals, and only the Y signal is used as a grayscale signal. However, the conversion method is not limited to this. In step S809, the binarization processing unit 603 converts the grayscale image signal into binary image data. As an example of the convention method, a threshold is set, and binary image data is generated to be “1” if the grayscale signal value is larger than the threshold, and “0” if it is smaller or equal. In step S810, the transmission unit 604 outputs the binary image data to the storage unit 405. The storage unit 405 receives the binary image data and saves it as transparent form image data.

By this control, transparent form image data can be registered in the storage unit of the MFP. When the user wants to print transparent form image data, he can use it by designating the registered transparent form image data via the operation unit of the external PC 102 or MFP.

<Transparent Toner Printing Result Preview Display>

A sequence for implementing a transparent toner printing result preview display will be described.

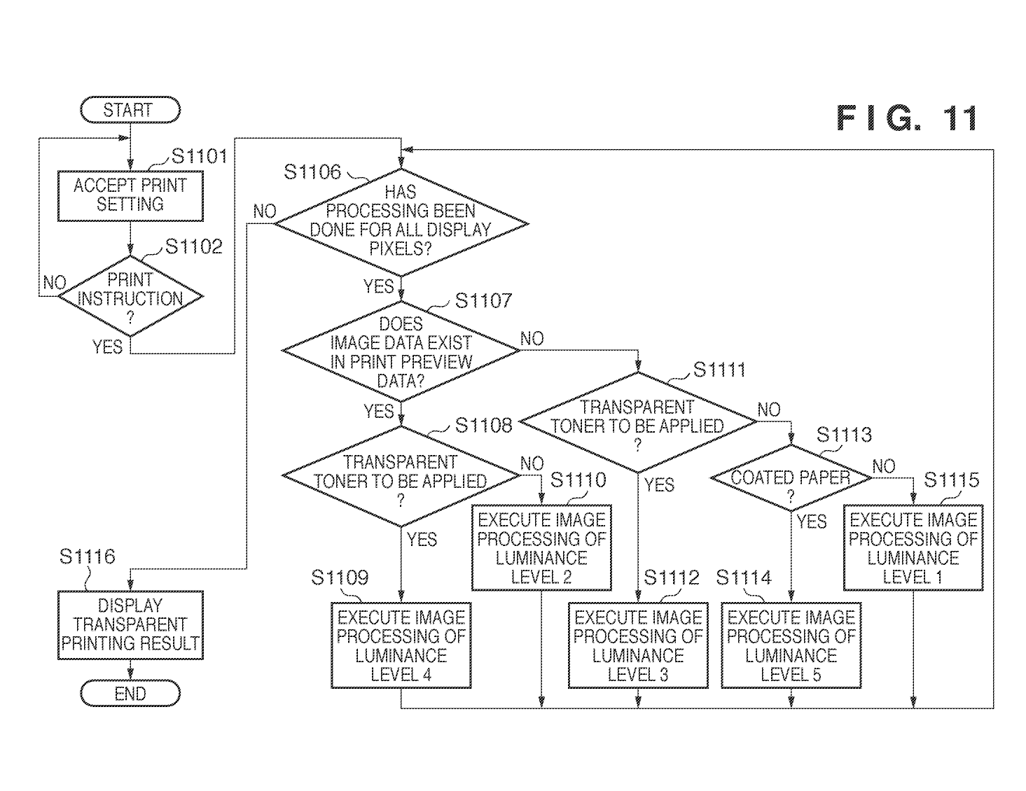

FIG. 11 is a flowchart showing the sequence of transparent toner printing result preview display processing by the local PC 102. For example, the CPU 307 of the local PC 102 executes the processing shown in FIG. 11.

In step S1101, the CPU 307 accepts a print setting from the user. For example, the CPU 307 accepts the setting of the type of paper used in printing. The type of paper includes plain paper and glossy paper, and the user selects the type of paper used in printing. Instead of designating the type of paper used in printing, the user may select one of paper feed units in the printing apparatus. When the user selects a paper feed unit, the CPU 307 changes subsequent control depending on whether the type of paper set in the paper feed unit is plain paper or glossy paper.

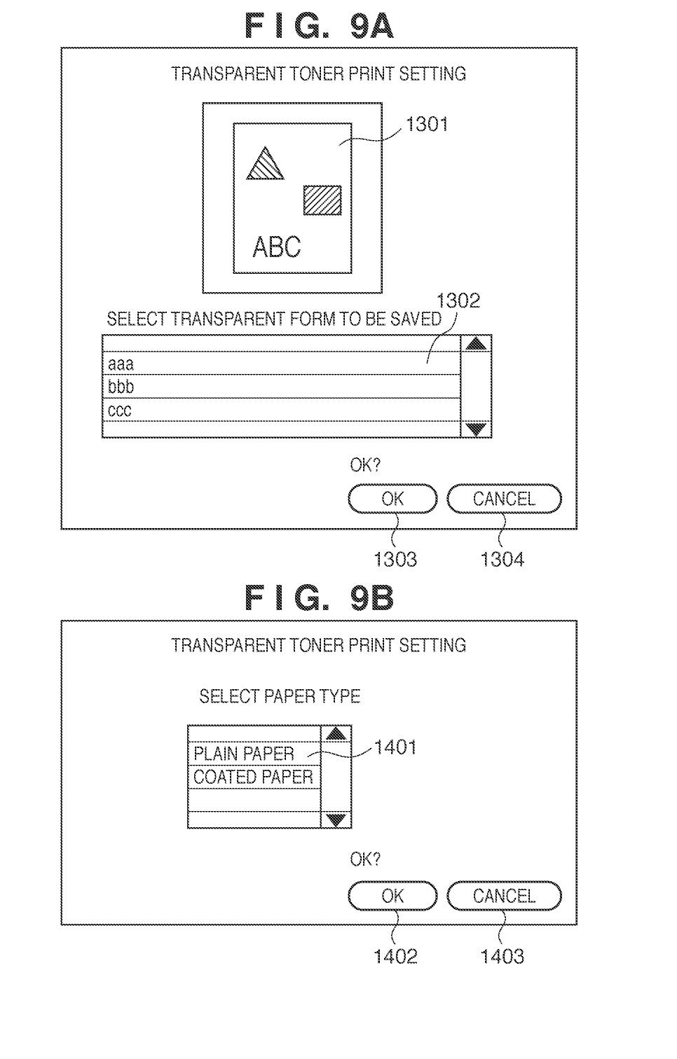

Also, the CPU 307 accepts selection of transparent form image data for use. The printer driver UI 302 displays a screen shown in FIG. 9A. The user selects a transparent form from the screen shown in FIG. 9A. The screen in FIG. 9A will be described later.

In step S1101, the CPU 307 displays a screen shown in FIG. 9B on the display in accordance with a user instruction. The user then selects the paper type from the screen shown in FIG. 9B. The screen in FIG. 9B will be described later.

After making various print settings in this way, the user presses an OK button to issue a print instruction.

In step S1102, the CPU 307 determines whether it has accepted the print instruction. If the CPU 307 determines that it has accepted the print instruction, the process advances to step S1106; if NO, the CPU 307 repeats the process in step S1101.

Step S1106 and subsequent steps are image processing for displaying a transparent toner print preview.

The CPU 307 determines a luminance level for each pixel by executing processes in steps S1106 to S1115. The luminance level corresponds to the luminance value. For example, the first embodiment prepares five luminance levels. When the luminance level is expressed by the luminance value, a luminance value of luminance level 5 is the largest, and that of luminance level 1 is the smallest. The interval between luminance levels 1 and 5 is equally divided into five, and the luminance level drops as it comes closer from luminance level 5 to luminance level 1.

In step S1106, the CPU 307 determines whether the processes in steps S1106 to S1115 have been completed for all display pixels. If the CPU 307 determines that the processes have ended for all pixels, the process advances to step S1116; if NO, to step S1107.

In step S1107, the preview image generation unit 305 determines whether print data selected in step S1101 exists in the pixel of interest in the preview image. The preview image generation unit 305 sets each pixel as the pixel of interest sequentially from, for example, the upper left corner of the image data. If one of the processes in steps S1110, S1112, S1114, and S1115 is performed for a given pixel of interest, the processes in steps S1106 to S1115 are executed for the next pixel of interest.

In step S1107, the preview image generation unit 305 determines whether image data to be printed exists in the pixel of interest. If the preview image generation unit 305 determines that the image data to be printed exists in the pixel of interest, the process advances to step S1108; if NO, to step S1111.

In step S1108, the preview image generation unit 305 determines whether to apply the transparent toner to the pixel of interest. More specifically, the preview image generation unit 305 determines, based on transparent form image data, whether to apply the transparent toner to the position of the pixel of interest. If the preview image generation unit 305 determines to apply the transparent toner, the process advances to step S1109; if NO, to step S1110.

In step S1111, similar to step S1108, the preview image generation unit 305 determines whether to apply the transparent toner to the pixel of interest. If the preview image generation unit 305 determines to apply the transparent toner, the process advances to step S1112; if NO, to step S1113.

In step S1113, the preview image generation unit 305 determines whether printing paper to be printed is coated paper or plain paper. If the preview image generation unit 305 determines that the printing paper is coated paper, the process advances to step S1114; if it determines that the printing paper is plain paper, to step S1115. In steps S1109, S1110, S1112, S1114, and S1115, the preview image generation unit 305 determines the luminance level of the pixel of interest, and performs corresponding image processing, details of which will be described later. In step S1116, the printer driver UI 302 previews the printing result in accordance with a luminance level determined for each pixel. Then, the process ends.

Selection of the transparent toner form will be explained.

FIG. 9A is a view showing a screen for selecting an arbitrary form from a plurality of transparent toner forms. First, the printer driver UI 302 selects, from a selection area 1302, transparent form image data used in printing from many saved transparent form image data. Then, the printer driver UI 302 displays a preview 1301 in the screen, and the user can confirm binary transparent form image data. The printer driver UI 302 designates applying the transparent toner to a portion displayed in the preview 1301 (portion having a logical value “1” in binary image data). A hatching portion indicates a set of pixels to which the transparent toner is applied. The user can determine a transparent form by pressing a button 1303, and cancel selection of a transparent form by pressing a button 1304.

Selection of the paper type in transparent toner print setting will be described.

FIG. 9B is a view showing a screen for setting transparent toner printing. The printer driver UI 302 displays the screen shown in FIG. 9B on the display. The user selects the type of printing paper from a displayed printing paper (paper) type selection area 1401. The user can determine a paper type by pressing a button 1402, and cancel selection of a paper type by pressing a button 1403.

In the description of the flowchart of FIG. 11, two paper types have been exemplified. However, image processing when generating a preview image can be changed depending on the difference in paper type. An image processing method to be executed is registered in advance for each paper type for use, and the storage unit 306 holds the registration result.

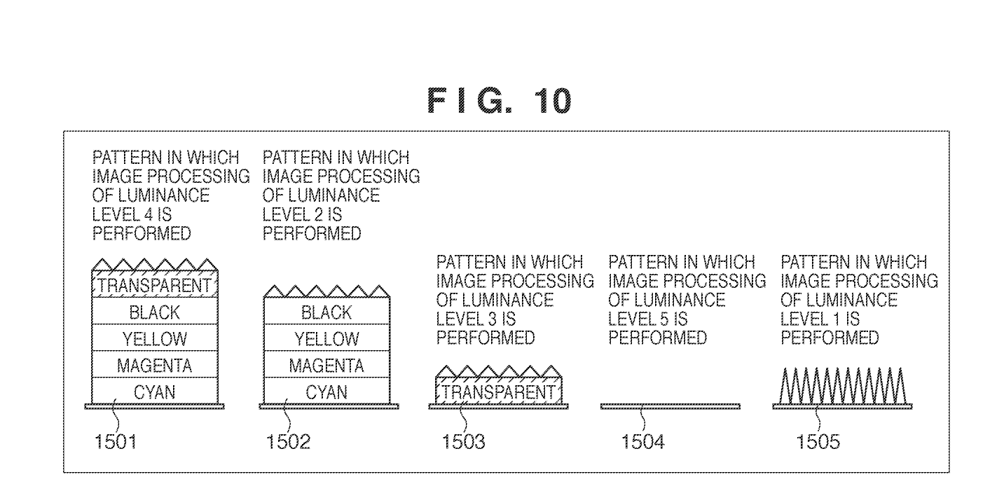

FIG. 10 is a view showing transparent toner surfaces in normal printing for respective cases in image processing performed by the preview image generation unit 305. A pattern 1501 represents a case in which the transparent toner is applied to a pixel having print data. A pattern 1502 represents a case in which no transparent toner is applied to a pixel having print data. A pattern 1503 represents a case in which the transparent toner is applied to a pixel having no print data. A pattern 1504 represents a case in which no transparent toner is applied to a pixel having no print data, and the printing paper is coated paper. A pattern 1505 represents a case in which no transparent toner is applied to a pixel having no print data, and the printing paper is plain paper. In the first embodiment, different luminance values are determined for the respective patterns 1501 to 1505 to perform image processing, and a texture obtained when printing on actual paper is expressed as a preview image. For example, as represented by the patterns 1501 and 1502, the preview is displayed so that the luminance is set higher at a portion where the transparent toner is applied, than at a portion where no transparent toner is applied at a portion having an image to be printed using color toners. This is because the transparent toner-applied portion becomes glossier.

For the pattern 1504, the surface of glossy paper is smooth, so the luminance value is increased to make the preview image glossier than other pixels. For the pattern 1505, the surface of plain paper is rugged, and thus the luminance parameter is decreased to make the preview image matter than other pixels.

The luminance values of the patterns 1502, 1503, and 1505 exhibit glossiness which is lower than that of the surface of glossy paper and higher than that of the surface of plain paper. Hence, the luminance level is set between the patterns 1504 and 1505.

A luminance parameter determined in advance for a pattern corresponding to each case is changed. As the change processing method, a pattern corresponding to each case is multiplied by a predetermined coefficient, as represented by equation (4):

$$( \begin{matrix}R 2 \\ G 2 \\ B 2\end{matrix} ) = ( \begin{matrix}N 1 & N 2 & N 3 \\ N 4 & N 5 & N 6 \\ N 7 & N 8 & N 9\end{matrix} ) ( \begin{matrix}R 1 \\ G 1 \\ B 1\end{matrix} ) \qquad ( 4 )$$

In the first embodiment, the luminance value is changed (R, G, and B values are changed). However, another parameter (for example, color difference value) may be changed.

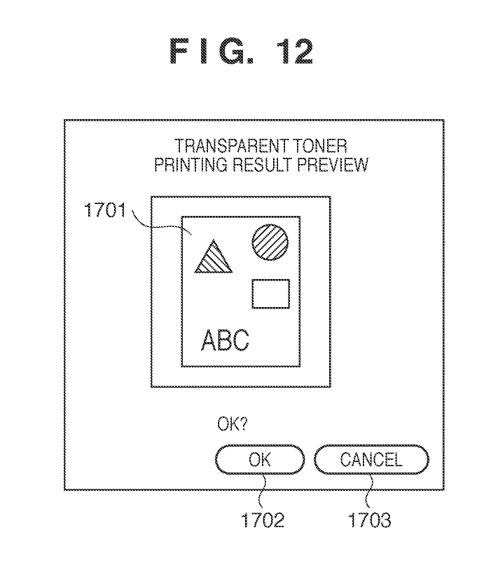

FIG. 12 is a view exemplifying a transparent toner printing result preview display. The printer driver UI 302 displays a preview result on a screen 1701 based on data generated by the preview image generation unit 305. In accordance with an instruction from a button 1702, the transmission unit 304 transmits PDL data generated by the printer driver 303 to the MFP 101. The user can designate cancellation using a button 1703.

<Printing Using Transparent Toner (in Normal Printing)>

In accordance with an instruction from the button 1702, the reception unit 501 of the PDL processing unit 401 receives PDL data from the local PC 102. The transmission unit 506 outputs compressed image data to the image processing unit 404.

The operation of the image processing unit 404 which has received compressed image data will be explained.

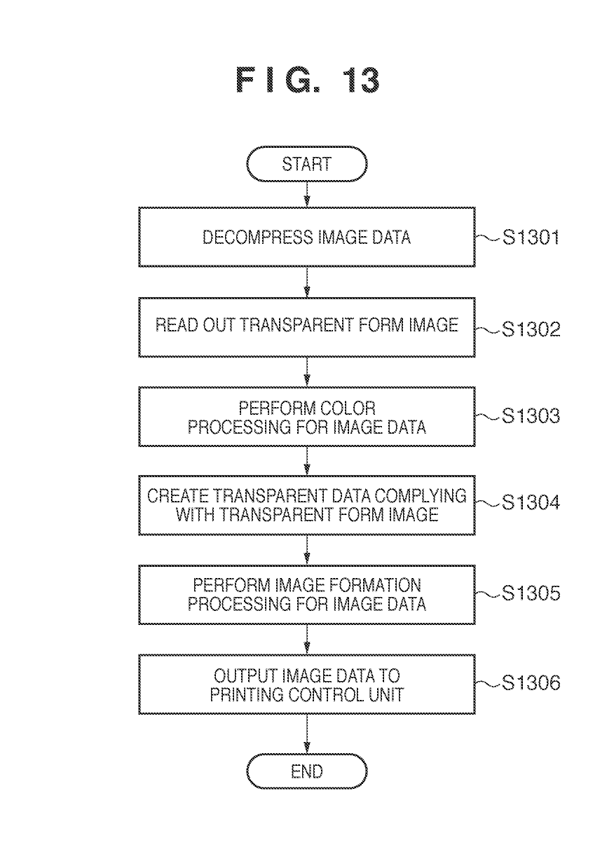

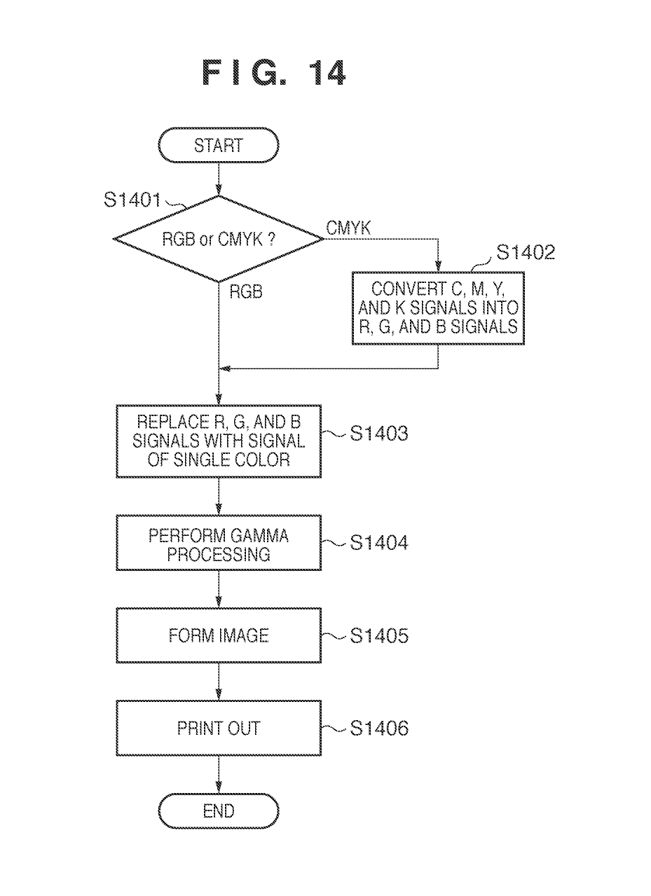

FIG. 13 is a flowchart showing the sequence of processing by the image processing unit 404. For example, the CPU 408 of the MFP 101 performs the processing shown in FIG. 13 by reading out and executing a program stored in the ROM (not shown). In step S1301, the decompression unit 701 of the image processing unit 404 decompresses received image data. In normal printout, the transparent form reception unit 702 reads out designated transparent form image data from the storage unit 405 in step S1302. When binary image data serving as transparent form image data needs to be inverted, the transparent form reception unit 702 also performs inversion processing. In step S1303, if the image data is RGB image data, the color processing unit 703 converts the RGB image data into CMYBk image data, and adjusts the density by arithmetic processing or the like. If the image data is CMYBk image data, the color processing unit 703 adjusts the density by arithmetic processing or the like.

In step S1304, the transparent toner processing unit 704 determines the transparent toner amount for a portion having a logical value “1” in the transparent form image data of binary image data. For a portion having a logical value “0”, the transparent toner processing unit 704 generates image data without any processing. In step S1305, the image formation processing unit 705 corrects the gamma set in the MFP 101 for each of plates (C, M, Y, Bk, and CL (transparent)), and performs image formation processing. The image formation processing method uses the screen and error diffusion. In step S1306, the transmission unit 706 outputs image data having undergone the image formation processing to the printing control unit 406. The printing control unit 406 selects a designated type of printing paper in accordance with information as shown in FIG. 9B that has been determined by the local PC 102, and then prints.

By this control, a preview when printing using the transparent toner can be displayed in consideration of the type of paper for use.

More specifically, the preview can be displayed by changing the texture between a region where the transparent toner is applied when applying the transparent toner onto plain paper, and a region where the transparent toner is applied when applying the transparent toner onto glossy paper.

Also, the preview can be displayed with different textures by changing the luminance value between a case in which the transparent toner is applied to a portion having color toners (C, M, Y, and Bk), and a case in which the transparent toner is applied directly onto paper.

### Second Embodiment

The first embodiment has described a transparent toner printing result preview method and printing in normal printing. The second embodiment will explain generation of a preview image in pre-printing.

<Pre-Printout Processing>

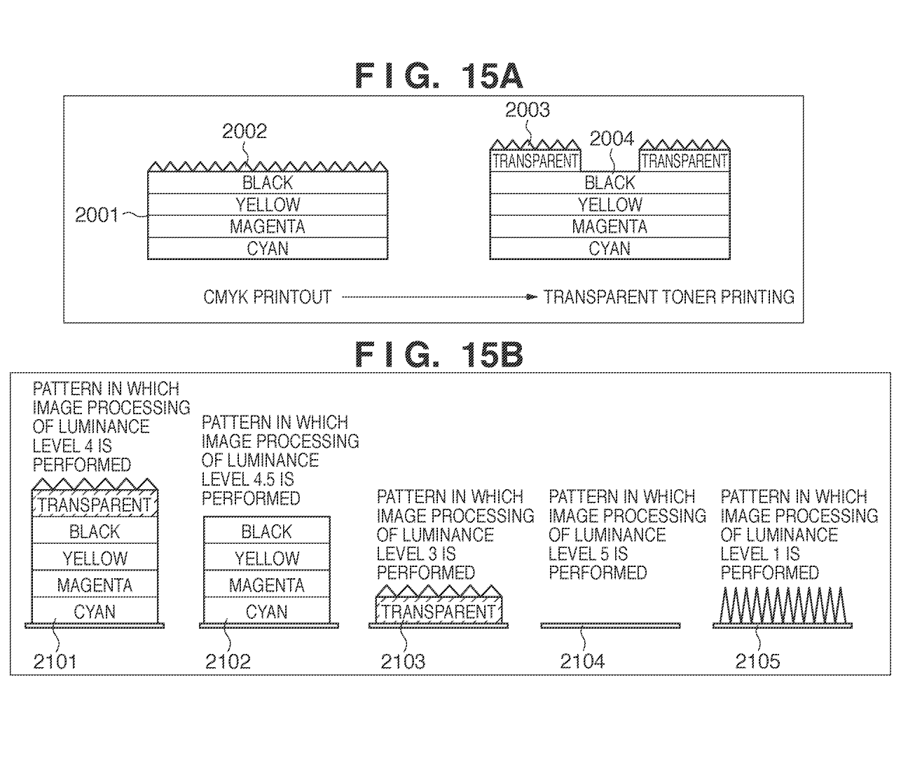

FIG. 14 is a flowchart showing the sequence of image processing and pre-printout processing performed by a data processing unit 211 of an MFP 101. For example, a CPU 408 of the MFP 101 performs the processing shown in FIG. 14 by reading out and executing a program stored in the ROM (not shown). In step S1401, a color processing unit 703 of an image processing unit 404 determines whether image signals input from a local PC 102 or the MFP 101 are R, G, and B signals or C, M, Y, and Bk signals. If the color processing unit 703 determines that the input image signals are C, M, Y, and Bk signals, the color processing unit 703 of the image processing unit 404 converts the C, M, Y, and Bk signals into R, G, and B signals in step S1402. The conversion method is matrix calculation as represented by equation (5):

$$( \begin{matrix}R \\ G \\ B\end{matrix} ) = ( \begin{matrix}B 1 & B 2 & B 3 & B 4 \\ B 5 & B 6 & B 7 & B 8 \\ B 9 & B 10 & B 11 & B 12\end{matrix} ) ( \begin{matrix}C \\ M \\ Y \\ B k\end{matrix} ) \qquad ( 5 )$$

In step S1403, the color processing unit 703 replaces the R, G, and B signals with one signal of a single color. The R, G, and B signals are converted using an arithmetic expression or the like, and the arithmetic expression is not particularly limited. Also, C, M, Y, and Bk signals are converted into R, G, and B signals, which are then replaced with one signal of a single color. However, C, M, Y, and Bk signals may be directly replaced with one signal of a single color. In step S1404, an image formation processing unit 705 of the image processing unit 404 corrects, for the signal of a single color, the gamma set in the MFP 101 for the transparent toner. In step S1405, the image formation processing unit 705 performs image formation processing. In step S1406, the MFP 101 prints an image using the CL toner. First, the MFP 101 prints sequentially in cyan, magenta, yellow, and black. Then, the user sets the CMYBk printout in the paper feed source of the MFP 101. The MFP 101 applies the transparent toner onto the set printout.

As described above, the pre-printout processing is the following print processing.

First, four, cyan, magenta, yellow, and black color toners are temporarily fixed onto printing paper, and the fixed printing paper is discharged. The user sets the discharged printing paper in the paper feed unit. The transparent toner is applied to the printing paper fed from the paper feed unit, discharging the printing paper. A printing method of completing printing by executing twice the print process from paper feed to discharge will be called “pre-printout”.

<Printing Effect of Transparent Toner in Pre-Printout>

FIG. 15A is a view showing the surface of the transparent toner in pre-printout. When pre-printing is done, a toner surface 2002 of a material 2001 printed in four, C, M, Y, and Bk remains slightly rugged, similar to normal printing. When the transparent toner is applied to part of the surface of the printed material 2001, a transparent toner-applied surface 2003 still remains slightly rugged. To the contrary, a surface 2004 printed in four, C, M, Y, and Bk passes through a fixing unit 227 twice, so the rugged surface 2002 becomes smooth like the surface 2004. In pre-printing, therefore, the surface (toner surface 2003) becomes matte by applying the transparent toner to a portion where the C, M, Y, and Bk toners have already been applied.

<Transparent Toner Printing Result Preview Display (Pre-Printout)>

A transparent toner printing result preview display sequence in pre-printout will be described with reference to FIG. 17. For example, a CPU 307 of the local PC 102 executes the processing shown in FIG. 17. Only the difference from the display sequence in normal printing described with reference to FIG. 11 will be explained. The sequence shown in FIG. 17 is different from that of FIG. 11 in step S1717. Steps S1701 to S1716 are the same as steps S1101 to S1116.

In step S1717, a preview image generation unit 305 determines which of normal printing or pre-printing is to be executed. The process in step S1717 is an example of mode determination processing in the second embodiment to determine whether to set a mode in which the transparent toner is applied after fixing the printing toner. If the preview image generation unit 305 determines to execute normal printing, the process advances to step S1710; if it determines to execute pre-printing, to step S1718. That is, pre-printout and normal printout are different in image processing method when image data to be printed exists in the pixel of interest and no transparent toner is applied.

FIG. 15B is a view showing transparent toner surfaces in pre-printing for respective cases in image processing performed by the preview image generation unit 305. Pre-printing differs from normal printing in that no transparent toner is applied to a pixel having print data, like a pattern 2102. As described above, the CMYBk toner surface becomes smooth by executing fixing processing once. For this reason, the luminance parameter is set higher than that for processing in normal printing so that image processing is performed to enhance glossiness. As represented by a pattern 2101 and the pattern 2102, the preview is displayed so that the luminance is set lower at a portion where the transparent toner is applied, than at a portion where no transparent toner is applied at a portion having print data.

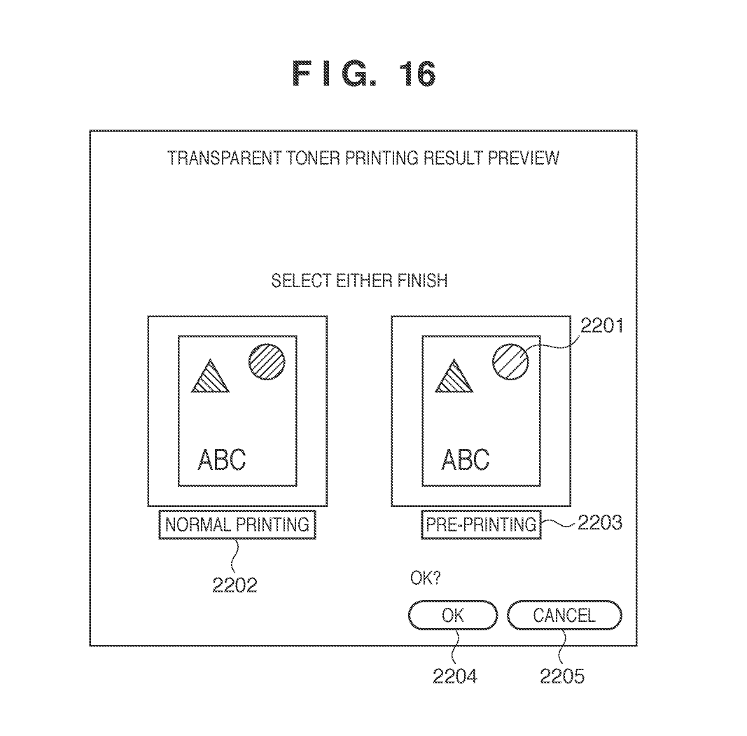

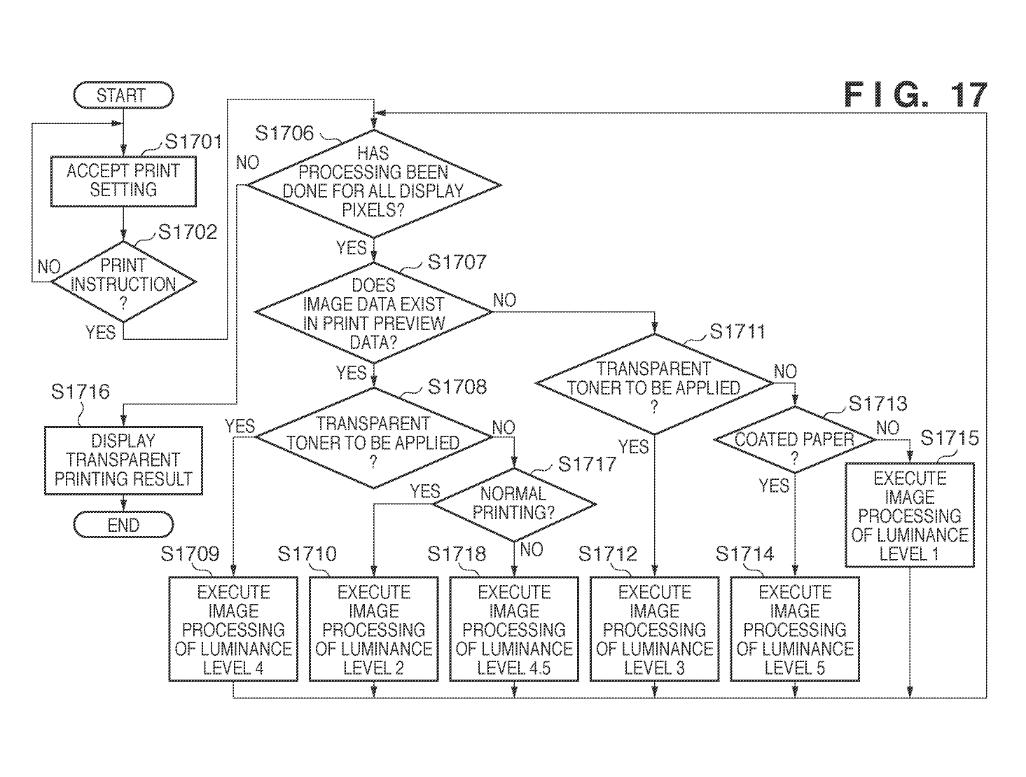

FIG. 16 is a view exemplifying a transparent toner printing result preview screen. A printer driver UI 302 displays a preview result based on data generated by the preview image generation unit 305. At this time, the previews of both normal printing and pre-printing are displayed. A display 2201 exhibits a portion having undergone image processing at luminance level 4.5 described with reference to FIG. 15B. The user selects a finish by pressing a button 2202 or button 2203. In accordance with an instruction from a button 2204, a transmission unit 304 transmits PDL data generated by a printer driver 303. The user can designate cancellation using a button 2205. In this fashion, a printing result in pre-printing can be expressed as a preview image. Note that luminance level 4.5 is a value between luminance levels 4 and 5.

[Printing Using Transparent Toner (in Pre-Printing)]

The operation of the image processing unit 404 in pre-printing will be explained.

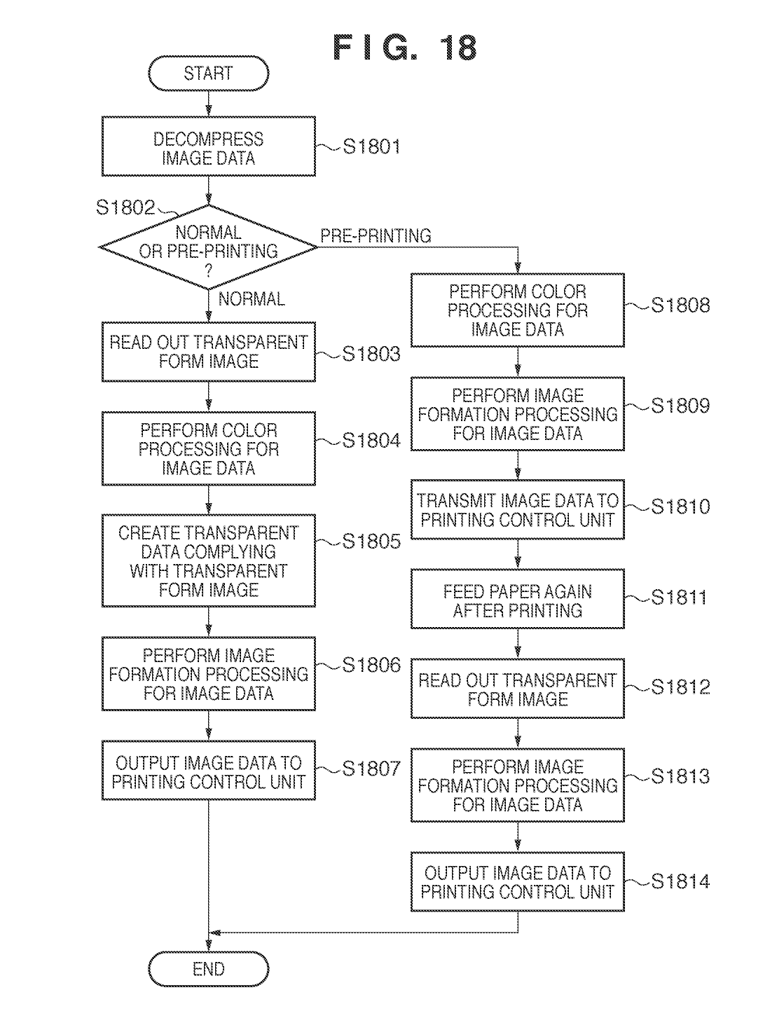

FIG. 18 is a flowchart for explaining the sequence of processing by the image processing unit 404 in pre-printing. For example, the CPU 408 of the MFP 101 performs the processing shown in FIG. 18. Steps S1801, and S1803 to S1807 are the same as steps S1301 and S1302 to S1306 in FIG. 13. In step S1802, the image processing unit 404 determines whether printing determined in FIG. 16 is normal printing or pre-printing. If the image processing unit 404 determines that the determined printing is pre-printing, the color processing unit 703 performs color processing for image data in step S1808. In step S1809, the image formation processing unit 705 corrects the gamma set in the MFP for each of plates (C, M, Y, and Bk), and performs image formation processing. In step S1810, a transmission unit 706 outputs image data having undergone the image formation processing to a printing control unit 406. The printing control unit 406 first prints image data of an image formed in C, M, Y, and Bk. After the end of printing, the printing control unit 406 discharges the sheet to the discharge mechanism of the MFP 101, and shifts to the standby state. Then, the printing control unit 406 prompts the user to set the discharged printed material in the paper feed source. In response to an instruction from the user to restart printing, the process advances to step S1811. In step S1811, the MFP 101 feeds one by one printed materials set in the paper feed source. In step S1812, a transparent form reception unit 702 reads out transparent form image data from a storage unit 405. When binary image data of transparent form image data needs to be inverted, the transparent form reception unit 702 also performs inversion processing. In step S1813, the image formation processing unit 705 corrects the gamma of the transparent toner set in the MFP for the transparent form image data, and performs image formation processing for the transparent toner. In step S1814, the transmission unit 706 outputs image data having undergone the image formation processing for the transparent toner to the printing control unit 406. Similar to the first embodiment, the printing control unit 406 selects a paper type in accordance with information determined in FIG. 9B, and then prints.

By this control, a preview can be displayed when performing pre-printout processing to complete printing in two processes by applying the transparent toner after temporarily fixing four, cyan, magenta, yellow, and black toners.

### Other Embodiments

In the first and second embodiments described above, the MFP prints image data received from an external PC. In addition, the MFP reads out, superimposes, and prints transparent form image data designated by the external PC. However, the present invention is not limited to this, and may be applied when the MFP executes copying. In this case, the MFP includes a display unit for displaying a preview image, and a display control unit for controlling a preview image to be displayed on the display unit. The MFP displays a paper type accepted from the user via the operation unit of the MFP, and transparent form image data. In accordance with an instruction to start printing from the user after displaying the preview image, the MFP prints image data.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-001566, filed Jan. 6, 2010, which is hereby incorporated by reference herein in its entirety.

1. An image processing apparatus comprising:
a printing unit configured to print on printing paper using a transparent toner;
a display unit configured to preview a result of printing by the printing unit; and
a display control unit configured to, when displaying a result of printing on plain paper using the transparent toner, control the display unit to display a luminance of a region where the transparent toner is applied, to be higher than a luminance of an image indicating the plain paper, and when displaying a result of printing on glossy paper using the transparent toner, control the display unit to display the luminance of the region where the transparent toner is applied, to be lower than a luminance of an image indicating the glossy paper.

2. The apparatus according to claim 1, wherein
the printing unit prints further using a color toner, and
the display control unit controls the display unit to display a luminance of a region where the color toner and the transparent toner are applied, to be higher than a luminance of a region where only the color toner is applied.

3. The apparatus according to claim 1, further comprising a registration unit configured to register transparent form image data indicating a region to be printed using the transparent toner,
wherein the printing unit prints using the transparent toner in a region indicated by the transparent form image data.

4. An information processing apparatus capable of communicating with a printing apparatus which prints on printing paper using a transparent toner, the information processing apparatus comprising:
a display unit configured to preview a result of printing by the printing apparatus; and
a display control unit configured to, when displaying a result of printing on plain paper using the transparent toner, control the display unit to display a luminance of a region where the transparent toner is applied, to be higher than a luminance of an image indicating the plain paper, and when displaying a result of printing on glossy paper using the transparent toner, controlling the display unit to display the luminance of the region where the transparent toner is applied, to be lower than a luminance of an image indicating the glossy paper.

5. A method of controlling an image processing apparatus, the method being executed by the image processing apparatus, the method comprising:
a printing step of printing on printing paper using a transparent toner;
a display step of causing a display unit to preview a result of printing in the printing step; and
a display control step of, when displaying a result of printing on plain paper using the transparent toner, controlling the display unit to display a luminance of a region where the transparent toner is applied, to be higher than a luminance of an image indicating the plain paper, and when displaying a result of printing on glossy paper using the transparent toner, controlling the display unit to display the luminance of the region where the transparent toner is applied, to be lower than a luminance of an image indicating the glossy paper.

6. A method of controlling an information processing apparatus, the method being executed by the information processing apparatus capable of communicating with a printing apparatus which prints on printing paper using a transparent toner, the method comprising:
a display step of causing a display unit to preview a result of printing by the printing apparatus; and
a display control step of, when displaying a result of printing on plain paper using the transparent toner, controlling the display unit to display a luminance of a region where the transparent toner is applied, to be higher than a luminance of an image indicating the plain paper, and when displaying a result of printing on glossy paper using the transparent toner, controlling the display unit to display the luminance of the region where the transparent toner is applied, to be lower than a luminance of an image indicating the glossy paper.

7. A computer-readable storage medium storing a program for causing a computer to execute the steps of an image processing apparatus control method according to claim 5.

8. A computer-readable storage medium storing a program for causing a computer to execute the steps of an information processing apparatus control method according to claim 6.
